(19) United States
(12) Patent Application Publication
(10) Pub. No.: US 2025/0302117 A1
(43) Pub. Date: Oct. 2, 2025

(54) AEROSOL GENERATING DEVICE

(71) Applicant: KT&G Corporation, Daejeon (KR)

(72) Inventors: Jueon PARK, Seoul (KR); Taehun KIM, Yongin-si (KR); Sungwook YOON, Gyeonggi-do (KR); Hyungjin JUNG, Seoul (KR); Jungho HAN, Daejeon (KR)

(73) Assignee: KT&G Corporation, Daejeon (KR)

(21) Appl. No.: 18/863,286

(22) PCT Filed: May 3, 2023
(86) PCT No.: PCT/KR2023/006009

§ 371 Date: Nov. 5, 2024

(30) Foreign Application Priority Data
May 9, 2022 (KR) 10-2022-0056865
Jun. 29, 2022 (KR) 10-2022-0079788

(51) Int. Cl. A24F 40/53; A24F 40/20; A24F 40/465; A24F 40/51; A24F 40/57; G01S 17/08; G01V 3/10

(52) U.S. Cl. CPC A24F 40/53; A24F 40/20; A24F 40/465; A24F 40/51; A24F 40/57; G01S 17/08; G01V 3/10

(57) ABSTRACT

An aerosol-generating device is disclosed. The aerosol-generating device of the disclosure includes a housing having an insertion space, a heater configured to heat a stick inserted into the insertion space, a first sensor, a second sensor, a power circuit configured to control supply of power to the second sensor, and a controller electrically connected to each of the first sensor and the second sensor. The first sensor is configured to output a first signal corresponding to s state of the insertion space to the controller and output a second signal corresponding to an insertion of the stick into the insertion space to the power circuit. The controller is configured to output a third signal corresponding to a fault to the power circuit based on the first sensor being defective. The power circuit is configured to supply the power to the second sensor based on receiving at least one of the second signal or the third signal.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to provide an aerosol-generating device capable of immediately activating a specific sensor upon insertion of a stick.

It is still another object of the present disclosure to provide an aerosol-generating device capable of appropriately changing a configuration for controlling supply of power to a specific sensor according to circumstances.

It is still another object of the present disclosure to provide an aerosol-generating device capable of minimizing an effect of an error occurring in any one of a plurality of sensors on other sensors.

### Solution to Problem

An aerosol-generating device according to an aspect of the present disclosure for accomplishing the above and other objects may include a housing having an insertion space, a heater configured to heat a stick inserted into the insertion space, a first sensor, a second sensor, a power circuit configured to control supply of power to the second sensor, and a controller electrically connected to each of the first sensor and the second sensor. The first sensor may output a first signal corresponding to s state of the insertion space to the controller and output a second signal corresponding to an insertion of the stick into the insertion space to the power circuit. The controller may output a third signal corresponding to a fault to the power circuit based on the first sensor being defective. The power circuit may supply the power to the second sensor based on receiving at least one of the second signal or the third signal.

### Advantageous Effects of Invention

According to at least one of embodiments of the present disclosure, it may be possible to immediately activate a specific sensor upon insertion of a stick.

According to at least one of embodiments of the present disclosure, it may be possible to appropriately change a configuration for controlling supply of power to a specific sensor according to circumstances.

According to at least one of embodiments of the present disclosure, it may be possible to minimize an effect of an error occurring in any one of a plurality of sensors on other sensors.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2 to 4 are views for explaining an aerosol-generating device according to embodiments of the present disclosure;

FIGS. 5 and 6 are views for explaining a stick according to embodiments of the present disclosure;

FIGS. 7 to 12 are diagrams for explaining configurations of an aerosol-generating device according to an embodiment of the present disclosure; and

FIG. 13 is a flowchart showing an operation method of the aerosol-generating device according to an embodiment of the present disclosure.

### MODE FOR THE INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

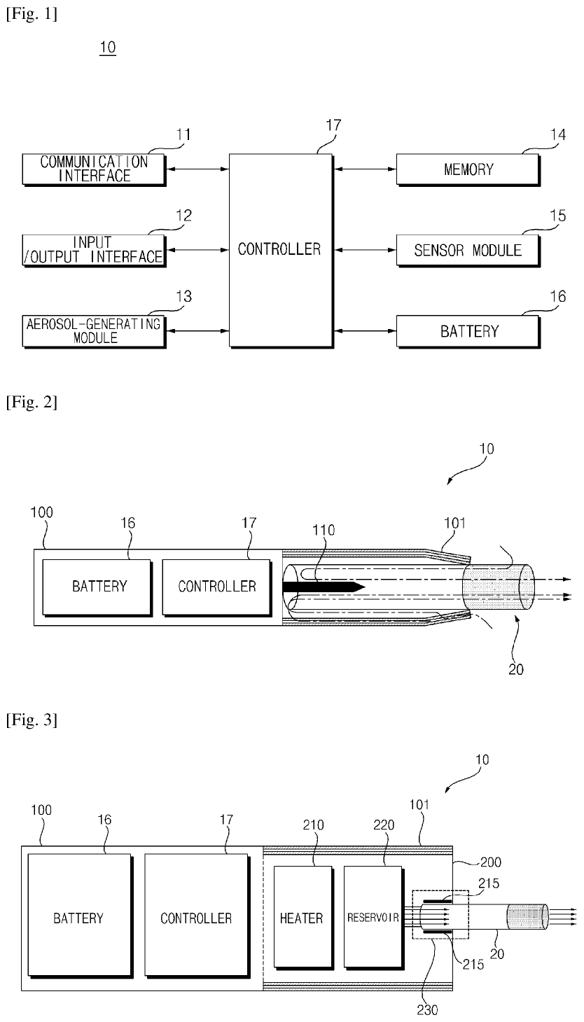

FIG. 1 is a block diagram of an aerosol-generating device according to an embodiment of the present disclosure.

Referring to FIG. 1, an aerosol-generating device 10 may include a communication interface 11, an input/output interface 12, an aerosol-generating module 13, a memory 14, a sensor module 15, a battery 16, and/or a controller 17.

In one embodiment, the aerosol-generating device 10 may be composed only of a main body. In this case, components included in the aerosol-generating device 10 may be located in the main body. In another embodiment, the aerosol-generating device 10 may be composed of a cartridge, which contains an aerosol-generating substance, and a main body. In this case, the components included in the aerosol-generating device 10 may be located in at least one of the main body or the cartridge.

The communication interface 11 may include at least one communication module for communication with an external device and/or a network. For example, the communication interface 11 may include a communication module for wired communication, such as a Universal Serial Bus (USB). For example, the communication interface 11 may include a communication module for wireless communication, such as Wireless Fidelity (Wi-Fi), Bluetooth, Bluetooth Low Energy (BLE), ZigBee, or nearfield communication (NFC).

The input/output interface 12 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 12 may transmit data corresponding to a command input by the user through the input device to another component (or other components) of the aerosol-generating device 100. The input/output interface 12 may output information corresponding to data received from another component (or other components) of the aerosol-generating device 10 through the output device.

The aerosol-generating module 13 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 13 may include at least one heater (not shown).

The aerosol-generating module 13 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 13 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 13 may generate ultrasonic vibrations to thereby generate an aerosol from the aerosol-generating substance.

The aerosol-generating device 10 may be referred to as a cartomizer, an atomizer, or a vaporizer.

The memory 14 may store programs for processing and controlling each signal in the controller 17. The memory 14 may store processed data and data to be processed.

For example, the memory 14 may store applications designed for the purpose of performing various tasks that can be processed by the controller 17. The memory 14 may selectively provide some of the stored applications in response to the request from the controller 17.

For example, the memory 14 may store data on the operation time of the aerosol-generating device 100, the maximum number of puffs, the current number of puffs, the number of uses of battery 16, at least one temperature profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 14 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 15 may include at least one sensor.

For example, the sensor module 15 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 15 may include a sensor for sensing the temperature of the heater included in the aerosol-generating module 13 and the temperature of the aerosol-generating substance (hereinafter referred to as a “temperature sensor”). In this case, the heater included in the aerosol-generating module 13 may also serve as the temperature sensor. For example, the electro-resistive material of the heater may be a material having a predetermined temperature coefficient of resistance. The sensor module 15 may measure the resistance of the heater, which varies according to the temperature, to thereby sense the temperature of the heater.

For example, in the case in which the main body of the aerosol-generating device 10 is formed to allow a stick to be inserted thereinto, the sensor module 15 may include a sensor for sensing insertion of the stick (hereinafter referred to as a “stick detection sensor”).

For example, in the case in which the aerosol-generating device 10 includes a cartridge, the sensor module 15 may include a sensor for sensing mounting/demounting of the cartridge and the position of the cartridge (hereinafter referred to as a “cartridge detection sensor”).

In this case, the stick detection sensor and/or the cartridge detection sensor may be implemented as an inductance-based sensor, a capacitive sensor, a resistance sensor, or a Hall sensor (or Hall IC) using a Hall effect.

For example, the sensor module 15 may include a voltage sensor for sensing a voltage applied to a component (e.g. the battery 16) provided in the aerosol-generating device 10 and/or a current sensor for sensing a current.

The battery 16 may supply electric power used for the operation of the aerosol-generating device 10 under the control of the controller 17. The battery 16 may supply electric power to other components provided in the aerosol-generating device 100. For example, the battery 16 may supply electric power to the communication module included in the communication interface 11, the output device included in the input/output interface 12, and the heater included in the aerosol-generating module 13.

The battery 16 may be a rechargeable battery or a disposable battery. For example, the battery 16 may be a lithium-ion (Li-ion) battery or a lithium polymer (Li-polymer) battery. However, the present disclosure is not limited thereto. For example, when the battery 16 is rechargeable, the charging rate (C-rate) of the battery 16 may be 10C, and the discharging rate (C-rate) thereof may be 10C to 20C. However, the present disclosure is not limited thereto. Also, for stable use, the battery 16 may be manufactured such that 80% or more of the total capacity may be ensured even when charging/discharging is performed 2000 times.

The aerosol-generating device 10 may further include a protection circuit module (PCM) (not shown), which is a circuit for protecting the battery 16. The protection circuit module (PCM) may be disposed adjacent to the upper surface of the battery 16. For example, in order to prevent overcharging and overdischarging of the battery 16, the protection circuit module (PCM) may cut off the electrical path to the battery 16 when a short circuit occurs in a circuit connected to the battery 16, when an overvoltage is applied to the battery 16, or when an overcurrent flows through the battery 16.

The aerosol-generating device 10 may further include a charging terminal to which electric power supplied from the outside is input. For example, the charging terminal may be formed at one side of the main body of the aerosol-generating device 100. The aerosol-generating device 10 may charge the battery 16 using electric power supplied through the charging terminal. In this case, the charging terminal may be configured as a wired terminal for USB communication, a pogo pin, or the like.

The aerosol-generating device 10 may wirelessly receive electric power supplied from the outside through the communication interface 11. For example, the aerosol-generating device 10 may wirelessly receive electric power using an antenna included in the communication module for wireless communication. The aerosol-generating device 10 may charge the battery 16 using the wirelessly supplied electric power.

The controller 17 may control the overall operation of the aerosol-generating device 100. The controller 17 may be connected to each of the components provided in the aerosol-generating device 100. The controller 17 may transmit and/or receive a signal to and/or from each of the components, thereby controlling the overall operation of each of the components.

The controller 17 may include at least one processor. The controller 17 may control the overall operation of the aerosol-generating device 10 using the processor included therein. Here, the processor may be a general processor such as a central processing unit (CPU). Of course, the processor may be a dedicated device such as an application-specific integrated circuit (ASIC), or may be any of other hardware-based processors.

The controller 17 may perform any one of a plurality of functions of the aerosol-generating device 100. For example, the controller 17 may perform any one of a plurality of functions of the aerosol-generating device 10 (e.g. a preheating function, a heating function, a charging function, and a cleaning function) according to the state of each of the components provided in the aerosol-generating device 10 and the user's command received through the input/output interface 12.

The controller 17 may control the operation of each of the components provided in the aerosol-generating device 10 based on data stored in the memory 14. For example, the controller 17 may control the supply of a predetermined amount of electric power from the battery 16 to the aerosol-generating module 13 for a predetermined time based on the data on the temperature profile, the user's inhalation pattern, which is stored in the memory 14.

The controller 17 may determine the occurrence or non-occurrence of a puff using the puff sensor included in the sensor module 15. For example, the controller 17 may check a temperature change, a flow change, a pressure change, and a voltage change in the aerosol-generating device 10 based on the values sensed by the puff sensor. The controller 17 may determine the occurrence or non-occurrence of a puff based on the value sensed by the puff sensor.

The controller 17 may control the operation of each of the components provided in the aerosol-generating device 10 according to the occurrence or non-occurrence of a puff and/or the number of puffs. For example, the controller 17 may perform control such that the temperature of the heater is changed or maintained based on the temperature profile stored in the memory 14.

The controller 17 may perform control such that the supply of electric power to the heater is interrupted according to a predetermined condition. For example, the controller 17 may perform control such that the supply of electric power to the heater is interrupted when the stick is removed, when the cartridge is demounted, when the number of puffs reaches the predetermined maximum number of puffs, when a puff is not sensed during a predetermined period of time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on the values sensed by the voltage sensor and/or the current sensor included in the sensor module 15.

The controller 17 may perform control such that electric power is supplied to the heater using at least one of a pulse width modulation (PWM) method or a proportional-integral-differential (PID) method.

For example, the controller 17 may perform control such that a current pulse having a predetermined frequency and a predetermined duty ratio is supplied to the heater using the PWM method. In this case, the controller 17 may control the amount of electric power supplied to the heater by adjusting the frequency and the duty ratio of the current pulse.

For example, the controller 17 may determine a target temperature to be controlled based on the temperature profile. In this case, the controller 17 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

Meanwhile, the controller 17 may perform control such that electric power is supplied to the heater according to a predetermined condition. For example, when a cleaning function for cleaning the space into which the stick is inserted is selected in response to a command input by the user through the input/output interface 12, the controller 17 may perform control such that a predetermined amount of electric power is supplied to the heater.

FIGS. 2 to 4 are views for explaining an aerosol-generating device according to embodiments of the present disclosure.

According to various embodiments of the present disclosure, the aerosol-generating device 10 may include a main body 100 and/or a cartridge 200.

Referring to FIG. 2, the aerosol-generating device 10 according to an embodiment may include a main body 100 and a cartridge 200. The main body 100 may support the cartridge 200, and the cartridge 200 may contain an aerosol-generating substance.

According to one embodiment, the cartridge 200 may be configured so as to be detachably mounted to the main body 100. According to another embodiment, the cartridge 200 may be integrally configured with the main body 100. For example, the cartridge 200 may be mounted to the main body 100 in a manner such that at least a portion of the cartridge 200 is inserted into the insertion space formed by a housing 101 of the main body 100.

The main body 100 may be formed to have a structure in which external air can be introduced into the main body 100 in the state in which the cartridge 200 is inserted thereinto. Here, the external air introduced into the main body 100 may flow into the user's mouth via the cartridge 200.

The controller 17 may determine whether the cartridge 200 is in a mounted state or a detached state using a cartridge detection sensor included in the sensor module 15. For example, the cartridge detection sensor may transmit a pulse current through a first terminal connected with the cartridge 200. In this case, the controller 17 may determine whether the cartridge 200 is in a connected state, based on whether the pulse current is received through a second terminal.

The cartridge 200 may include a reservoir 220 configured to contain the aerosol-generating substance and/or a heater 210 configured to heat the aerosol-generating substance in the reservoir 220. For example, a liquid delivery element impregnated with (containing) the aerosol-generating substance may be disposed inside the reservoir 220. The electrically conductive track of the heater 210 may be formed in a structure that is wound around the liquid delivery element. In this case, when the liquid delivery element is heated by the heater 210, an aerosol may be generated. Here, the liquid delivery element may include a wick made of, for example, cotton fiber, ceramic fiber, glass fiber, or porous ceramic.

The cartridge 200 may include a mouthpiece 225. Here, the mouthpiece 225 may be a portion to be inserted into a user's oral cavity. The mouthpiece 225 may have a discharge hole through which the aerosol is discharged to the outside during a puff.

Referring to FIG. 3, the cartridge 200 may include an insertion space 230 configured to allow a stick 20 to be inserted. For example, the cartridge 200 may include the insertion space formed by an inner wall extending in a circumferential direction along a direction in which the stick 20 is inserted. In this case, the insertion space may be formed by opening the inner side of the inner wall up and down. The stick 20 may be inserted into the insertion space formed by the inner wall.

The insertion space into which the stick 20 is inserted may be formed in a shape corresponding to the shape of a portion of the stick 20 inserted into the insertion space. For example, when the stick 20 is formed in a cylindrical shape, the insertion space may be formed in a cylindrical shape.

When the stick 20 is inserted into the insertion space, the outer surface of the stick 20 may be surrounded by the inner wall and contact the inner wall.

A portion of the stick 20 may be inserted into the insertion space, the remaining portion of the stick 20 may be exposed to the outside.

The user may inhale the aerosol while biting one end of the stick 20 with the mouth. The aerosol generated by the heater 210 may pass through the stick 20 and be delivered to the user's mouth. At this time, while the aerosol passes through the stick 20, the material contained in the stick 20 may be added to the aerosol. The material-infused aerosol may be inhaled into the user's oral cavity through the one end of the stick 20.

The controller 17 may monitor the number of puffs based on the value sensed by the puff sensor from the point in time at which the stick 20 was inserted.

When the stick 20 is removed, the controller 17 may initialize the current number of puffs stored in the memory 14.

The cartridge 200 may include a second heater 215 configured to heat the stick 20. The second heater 215 may be disposed in the cartridge 200 at a position corresponding to a position at which the stick 20 is located after being inserted into the insertion space 230. The second heater 215 may be implemented as an electrically conductive heater and/or an induction heating type heater. The second heater 215 may heat the inside and/or the outside of the stick 20 using the power supplied from the battery 16.

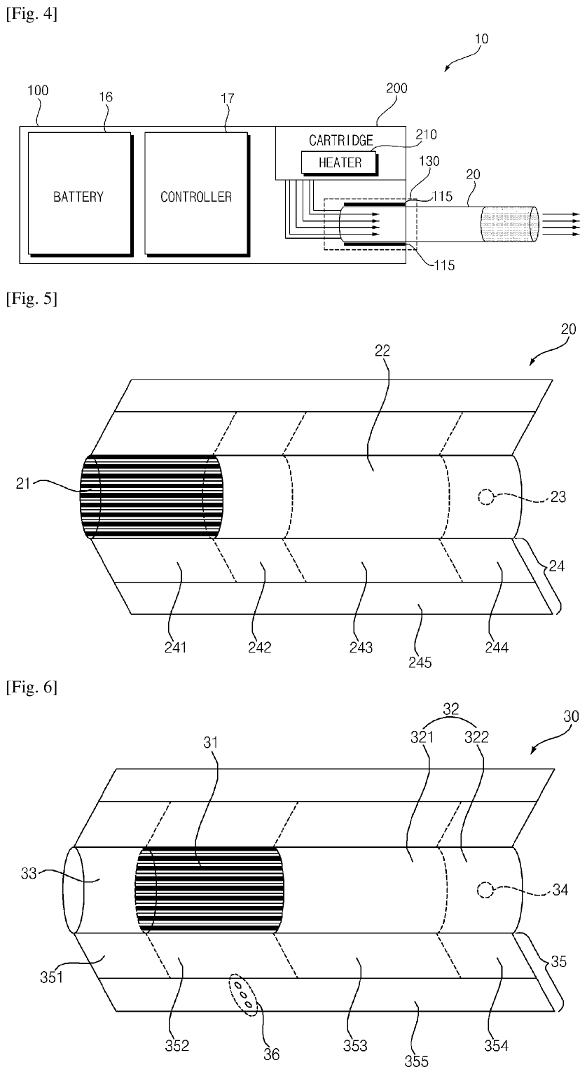

Referring to FIG. 4, the aerosol-generating device 10 according to an embodiment may include a main body 100 supporting the cartridge 200 and a cartridge 200 containing an aerosol-generating substance. The main body 100 may be formed so as to allow the stick 20 to be inserted into an insertion space 1300 therein.

The aerosol-generating device 10 may include the first heater 210 for heating for heating the aerosol-generating substance stored in the cartridge 200 and/or the second heater 215 for heating the stick 20 inserted into the main body 100. For example, the aerosol-generating device 10 may generate an aerosol by heating the aerosol-generating substance stored in the cartridge 200 and the stick 20 using the first heater 210 and the second heater 115, respectively.

The stick 20 may be similar to a general combustive cigarette. For example, the stick 20 may be divided into a first portion including an aerosol generating material and a second portion including a filter and the like. Alternatively, an aerosol generating material may be included in the second portion of the stick 20. For example, a flavoring substance made in the form of granules or capsules may be inserted into the second portion.

Hereinafter, the present disclosure will be described on the basis of an embodiment in which the stick 20 is inserted into the insertion space 130 defined in the housing 101 of the main body 100.

FIGS. 5 and 6 are views for explaining a stick according to embodiments of the present disclosure.

Referring to FIG. 5, the stick 20 may include a tobacco rod 21 and a filter rod 22. The first portion described above with reference to FIG. 4 may include the tobacco rod. The second portion described above with reference to FIG. 4 may include the filter rod 22.

FIG. 5 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

A diameter of the stick 20 may be within a range of 5 mm to 9 mm, and a length of the stick 20 may be about 48 mm, but embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm, but embodiments are not limited thereto.

The stick 20 may be wrapped using at least one wrapper 24. The wrapper 24 may have at least one hole through which external air may be introduced or internal air may be discharged. For example, the stick 20 may be wrapped using one wrapper 24. As another example, the stick 20 may be double-wrapped using at least two wrappers 24. For example, the tobacco rod 21 may be wrapped using a first wrapper 241. For example, the filter rod 22 may be wrapped using wrappers 242, 243, 244. The tobacco rod 21 and the filter rod 22 wrapped by wrappers may be combined. The stick 20 may be re-wrapped by a single wrapper 245. When each of the tobacco rod 21 and the filter rod 22 includes a plurality of segments, each segment may be wrapped using wrappers 242, 243, 244. The entirety of stick 20 composed of a plurality of segments wrapped by wrappers may be re-wrapped by another wrapper

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and an aluminum laminate packaging material.

The third wrapper 243 may be made of a hard wrapping paper. For example, a basis weight of the third wrapper 243 may be within a range of 88 g/m² to 96 g/m². For example, the basis weight of the third wrapper 243 may be within a range of 90 g/m² to 94 g/m². Also, a total thickness of the third wrapper 243 may be within a range of 1200 μm to 1300 μm. For example, the total thickness of the third wrapper 243 may be 125 μm.

The fourth wrapper 244 may be made of an oil-resistant hard wrapping paper. For example, a basis weight of the fourth wrapper 244 may be within a range of about 88 g/m2 to about 96 g/m². For example, the basis weight of the fourth wrapper 244 may be within a range of 90 g/m² to 94 g/m². Also, a total thickness of the fourth wrapper 244 may be within a range of 1200 μm to 1300 μm. For example, the total thickness of the fourth wrapper 244 may be 125 μm.

The fifth wrapper 245 may be made of a sterilized paper (MFW). Here, the MFW refers to a paper specially manufactured to have enhanced tensile strength, water resistance, smoothness, and the like, compared to ordinary paper. For example, a basis weight of the fifth wrapper 245 may be within a range of 57 g/m² to 63 g/m². For example, a basis weight of the fifth wrapper 245 may be about 60 g/m². Also, the total thickness of the fifth wrapper 245 may be within a range of 64 μm to 70 μm. For example, the total thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the stick 20 from being burned. For example, when the tobacco rod 21 is heated by the heater 110, there is a possibility that the stick 20 is burned. In detail, when the temperature is raised to a temperature above the ignition point of any one of materials included in the tobacco rod 21, the stick 20 may be burned. Even in this case, since the fifth wrapper 245 include a non-combustible material, the burning of the stick 20 may be prevented.

Furthermore, the fifth wrapper 245 may prevent the aerosol generating device 100 from being contaminated by substances formed by the stick 20. Through puffs of a user, liquid substances may be formed in the stick 20. For example, as the aerosol formed by the stick 20 is cooled by the outside air, liquid materials (e.g., moisture, etc.) may be formed. As the fifth wrapper 245 wraps the stick 20, the liquid materials formed in the stick 20 may be prevented from being leaked out of the stick 20.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. The first segment may prevent an internal material of the tobacco rod 21 from being pushed back when the heater 110 is inserted into the tobacco rod 21 and may also provide a cooling effect to aerosol. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm but is not limited thereto.

The second segment of the filter rod 22 cools the aerosol which is generated when the heater 110 heats the tobacco rod 21. Therefore, the user may puff the aerosol which is cooled at an appropriate temperature.

The length or diameter of the second segment may be variously determined according to the shape of the stick 20. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulous acetate (CA), and aluminum coil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm2/mm and about 1000 mm2/mm. In addition, an aerosol cooling element may be formed from a material having a specific surface area between about 10 mm2/mg and about 100 mm2/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulous acetate filter. The length of the third segment may be an appropriate length within a range of 4 mm to 20 mm. For example, the length of the third segment may be about 12 mm but is not limited thereto.

The filter rod 22 may be manufactured to generate flavors. For example, a flavoring liquid may be injected onto the filter rod 22. For example, an additional fiber coated with a flavoring liquid may be inserted into the filter rod 22.

Also, the filter rod 22 may include at least one capsule 23. Here, the capsule 23 may generate a flavor. The capsule 23 may generate an aerosol. For example, the capsule 23 may have a configuration in which a liquid including a flavoring material is wrapped with a film. The capsule 23 may have a spherical or cylindrical shape but is not limited thereto.

Referring to FIG. 6, a stick 30 may further include a front-end plug 33. The front-end plug 33 may be located on a side of a tobacco rod 31, the side not facing a filter rod 32. The front-end plug 33 may prevent the tobacco rod 31 from being detached and prevent liquefied aerosol from flowing into the aerosol generating device 10 from the tobacco rod 31, during smoking.

The filter rod 32 may include a first segment 321 and a second segment 322. The first segment 321 may correspond to the first segment of the filter rod 22 of FIG. 4. The segment 322 may correspond to the third segment of the filter rod 22 of FIG. 4.

A diameter and a total length of the stick 30 may correspond to the diameter and a total length of the stick 20 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The stick 30 may be wrapped using at least one wrapper 35. The wrapper 35 may have at least one hole through which external air may be introduced or internal air may be discharged. For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire stick 30 may be re-wrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. For example, the perforation 36 may transfer heat formed by the heater 210 illustrated in FIG. 3 into the tobacco rod 31.

Also, the second segment 322 may include at least one capsule 34. Here, the capsule 34 may generate a flavor. The capsule 34 may generate an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with a metal foil such as an aluminum coil. For example, a total thickness of the first wrapper 351 may be within a range of 45 μm to 55 μm. For example, the total thickness of the first wrapper 351 may be 50.3 μm. Also, a thickness of the metal coil of the first wrapper 351 may be within a range 6 μm to 7 μm. For example, the thickness of the metal coil of the first wrapper 351 may be 6.3 μm. In addition, a basis weight of the first wrapper 351 may be within a range of 50 g/m² to 55 g/m². For example, the basis weight of the first wrapper 351 may be 53 g/m2.

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m² to 25 g/m². For example, the basis weight of the second wrapper 352 may be 23.5 g/m2.

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m² to about 25 g/m2. For example, the basis weight of the third wrapper 353 may be 21 g/m2.

The fourth wrapper 354 may be formed of PLA laminated paper. Here, the PLA laminated paper refers to three-layer paper including a paper layer, a PLA layer, and a paper layer. For example, a thickness of the fourth wrapper 353 may be in a range of 100 μm to 1200 μm. For example, the thickness of the fourth wrapper 353 may be 110 μm. Also, a basis weight of the fourth wrapper 354 may be in a range of 80 g/m² to 100 g/m². For example, the basis weight of the fourth wrapper 354 may be 88 g/m².

The fifth wrapper 355 may be formed of sterilized paper (MFW). Here, the sterilized paper (MFW) refers to paper which is particularly manufactured to improve tensile strength, water resistance, smoothness, and the like more than ordinary paper. For example, a basis weight of the fifth wrapper 355 may be in a range of 57 g/m² to 63 g/m². For example, the basis weight of the fifth wrapper 355 may be 60 g/m². Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulous acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a Y shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 4. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a Y shape. Total denier of the second segment 322 may be in a range of 20000 to 30000. For example, the total denier of the second segment 322 may be 25000.

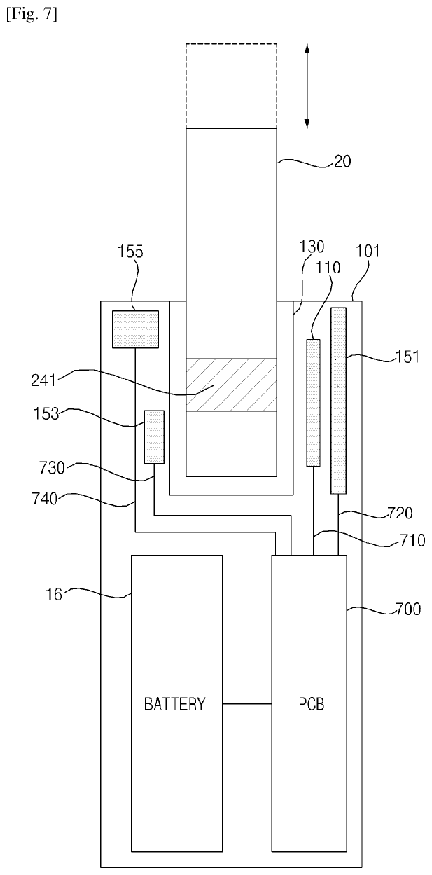

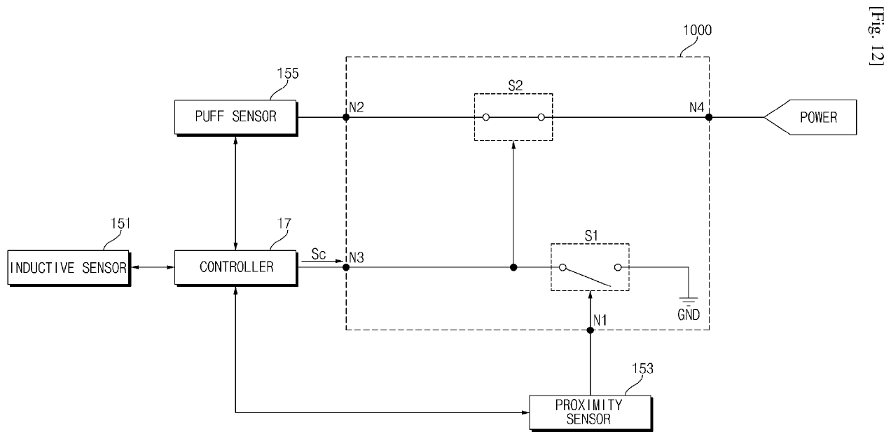

FIGS. 7 to 12 are diagrams for explaining configurations of an aerosol-generating device according to an embodiment of the present disclosure.

Referring to FIG. 7, the aerosol generating device 10 may include a housing 101 having an insertion space 130, a heater 110, a plurality of sensors 151, 153, and 155, a battery 16, and/or a printed circuit board 700.

The insertion space 130 may be a space defined in the housing 101, which forms the external appearance of the aerosol-generating device 10. One end of the insertion space 130 may be open to form an opening. The insertion space 130 may be exposed to the outside through the opening. The opening may be defined as one end of the insertion space 130.

The stick 20 may be inserted into the insertion space 130. The insertion space 130 may be formed in a shape corresponding to the shape of the stick 20. For example, when the stick 20 has a circular cross-section, the insertion space 130 may be formed in a cylindrical shape. A portion of the stick 20 may be inserted into the insertion space 130. The remaining portion of the stick 20 other than the portion thereof inserted into the insertion space 130 may be exposed to the outside.

The heater 110 may be disposed adjacent to the insertion space 130. The heater 110 may heat the inside and/or the outside of the stick 20 using the power supplied from the battery 16. The heater 110 may be implemented as an electrically conductive heater and/or an induction heating type heater.

An inductive sensor 151 may include at least one coil. The coil of the inductive sensor 151 may be disposed adjacent to the insertion space 130. For example, when a magnetic field changes around the coil, through which current flows, a characteristic of the current flowing through the coil may change according to Faraday's law of electromagnetic induction. Here, the characteristic of the current flowing through the coil may include a frequency of alternating current, a current value, a voltage value, an inductance value, an impedance value, and the like.

The inductive sensor 151 may output a signal corresponding to the characteristic of the current flowing through the coil. For example, the inductive sensor 151 may output a signal corresponding to the inductance value of the coil. For example, when the stick 20 including the first wrapper 241 made of metal is inserted into the insertion space 130, the magnetic field around the coil may be changed by the first wrapper 241. At this time, the inductance of the coil may change in response to the change in the magnetic field by the first wrapper 241.

According to one embodiment, the aerosol generating device 10 may include a capacitance sensor. The capacitance sensor may include an electrode formed to surround at least a portion of the insertion space 130. The electrode may be formed of a conductive material. For example, the electrode may be formed of a metal material having high conductivity, such as gold, silver, copper, or aluminum.

A level of the signal of the capacitance sensor may mean a value corresponding to capacitance around the electrode provided in the capacitance sensor. When the stick 20 is inserted into the insertion space 130, the capacitance around the electrode provided in the capacitance sensor may vary due to the stick 20 inserted into the insertion space 130.

Meanwhile, a degree of change in the level of the signal of the capacitance sensor may correspond to an amount of moisture included in the stick 20. For example, as the amount of moisture contained in the stick 20 increases, the degree of change in the level of the signal of the capacitive sensor 150 in response to the insertion of the stick 20 into the insertion space 130 may increase.

The proximity sensor 153 may detect an object inserted into the insertion space 130 and placed close to it. The proximity sensor 153 may be disposed to face the insertion space 130. The proximity sensor 153 may be disposed adjacent to the lower end of the insertion space 130.

The proximity sensor 153 may be an optical proximity sensor. Hereinafter, it will be described as an example that the proximity sensor 153 is the optical proximity sensor. The proximity sensor 153 may emit light toward the insertion space 130. The proximity sensor 153 may include a light-emitting element that emits light toward the insertion space 130 and a light-receiving element that outputs a signal corresponding to incident light.

The light-emitting element may emit infrared rays having a wavelength of 780 nm to 1 mm. The light-emitting element may include a light emitting diode (LED), an organic light emitting diode (OLED), a laser diode (LD), or the like as a light source. The proximity sensor 153 may include a first light collecting element that collects light generated from the light source toward the insertion space 130. Here, the first light concentrating element may be composed of an imaging lens, a diffractive optical element (DOE), and the like.

The light-receiving element may include a photo diode, a photo transistor, or the like that responds to light. The proximity sensor 153 may include a second light concentrating element that collects reflected light emitted from the light source. For example, the reflected light condensed by the second light concentrating element may be transferred to the photodiode. In this case, the second light collecting element may include a lens that receives reflected light incident from a predetermined direction.

The proximity sensor 153 may further include an optical filter that restricts transmission of light in a specific wavelength range. For example, when the light source emits infrared rays having a wavelength of 780 nm to 1 mm, the optical filter may be configured as an infrared pass filter that restricts transmission of infrared rays.

According to one embodiment, the aerosol generating device 10 may further include a color sensor for detecting a color of an object. The color sensor may detect a value of an optical characteristic corresponding to the color of the object based on light reflected from the object. For example, the optical characteristic may be a wavelength of light. The color sensor may be implemented as one component with the proximity sensor 153 or may be implemented as a separate component distinct from the proximity sensor 153. In the present disclosure, it is described that the color sensor is implemented as one component with the proximity sensor 153, but is not limited thereto.

A color of at least a portion of the wrapper 24 constituting the stick 20 may be changed by aerosol. The color sensor may be disposed corresponding to a position where the at least a portion of the wrapper 24 whose color is changed by aerosol is disposed when the stick 20 is inserted into the insertion space 130. For example, before the stick 20 is used by the user, the at least a portion of the wrapper 24 may have a first color. In this case, as the at least a portion of the wrapper 24 is wetted by the aerosol while the aerosol generated by the aerosol generating device 10 passes through the stick 20, the color of the at least a portion of the wrapper 24 may be changed to a second color. Meanwhile, the color of the at least a portion of the wrapper 24 may be maintained as the second color after being changed from the first color to the second color.

The puff sensor 155 may detect a flow of gas flowing into the housing 101. The puff sensor 155 may output a signal corresponding to a puff. For example, the puff sensor 155 may output a signal corresponding to the internal pressure of the aerosol-generating device 10. Here, the internal pressure of the aerosol-generating device 10 may correspond to the pressure in a flow path through which gas flows. In this embodiment, the puff sensor 155 is described as being implemented as a pressure sensor configured to output a signal corresponding to the internal pressure of the aerosol-generating device 10, but the present disclosure is not limited thereto.

The components of the aerosol-generating device 10 may be mounted on one surface and/or the opposite surface of the printed circuit board 700. The components mounted on the printed circuit board 700 may transmit or receive signals therebetween through a wiring layer of the printed circuit board 700. The controller 17 may be mounted on the printed circuit board 700. At least some of the components included in a power line implemented to supply power to each component provided in the aerosol generating device 10 may be mounted on the printed circuit board 700.

The printed circuit board 700 may be disposed adjacent to the battery 16. For example, the printed circuit board 700 may be disposed such that one surface thereof faces the battery 16. The printed circuit board 700 may be electrically connected to the battery 16.

The heater 110 may be electrically connected to the printed circuit board 700 through a first flexible printed circuit board (FPCB) 710. Power charged in the battery 16 may be supplied to the heater 110 via the printed circuit board 700 and the first flexible printed circuit board 710.

Each of the plurality of sensors 151, 153, and 155 may be electrically connected to the printed circuit board 700 through corresponding flexible printed circuit boards 720, 730, and 740, respectively. The plurality of sensors 151, 153, and 155 may be receive power through the corresponding flexible printed circuit boards 720, 730, and 740, respectively. Power lines respectively corresponding to the plurality of sensors 151, 153, and 155 may be configured to be electrically disconnected from each other. Signals output from the plurality of sensors 151, 153, and 155 may be transmitted to the controller 17 mounted on the printed circuit board 700 through the corresponding flexible printed circuit boards 720, 730, and 740, respectively. Signal lines implemented to transmit signals corresponding to each of the plurality of sensors 151, 153, and 155 may be configured to be electrically disconnected from each other.

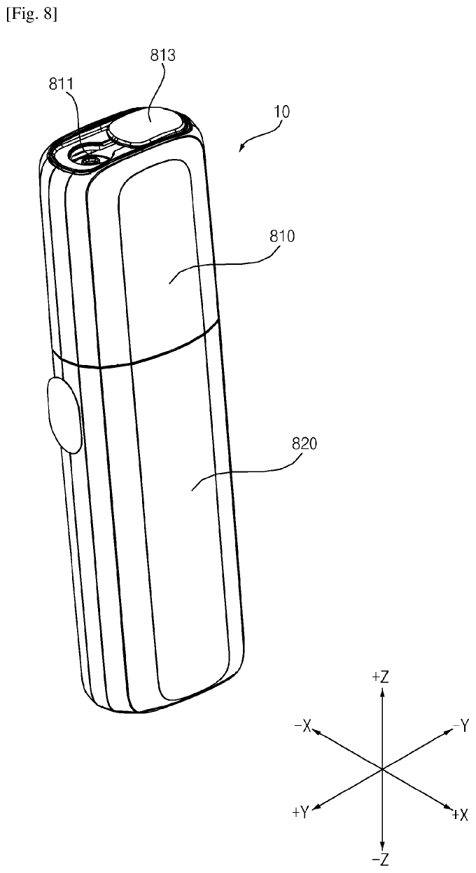

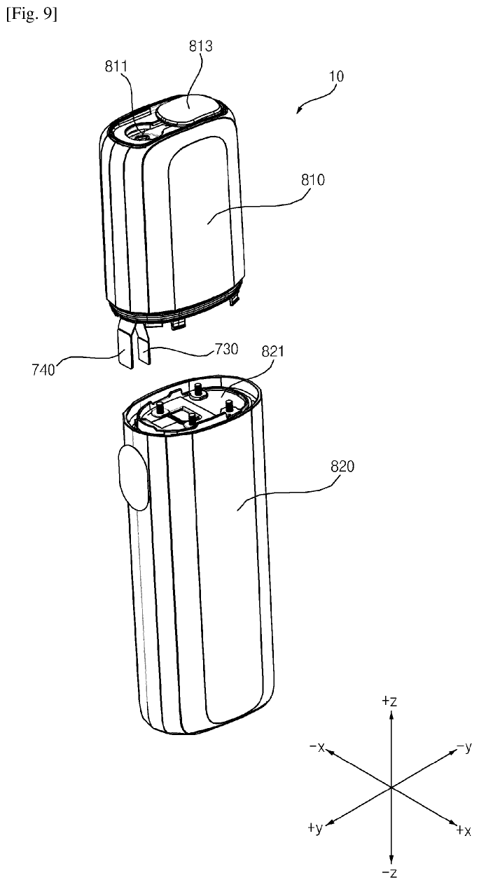

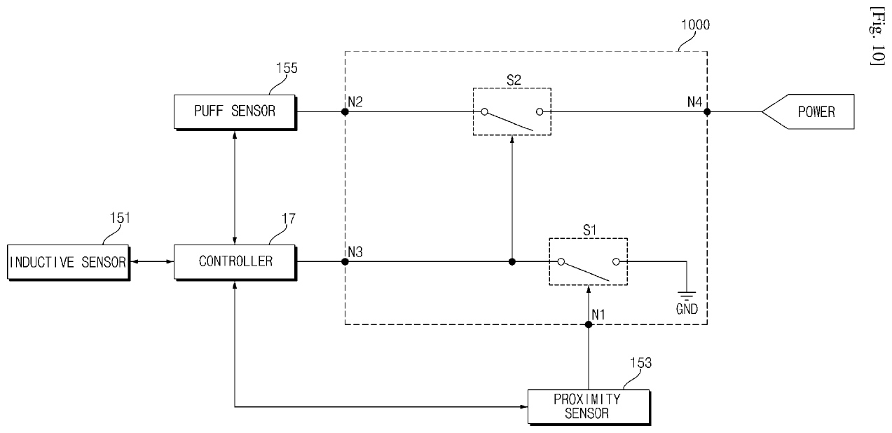

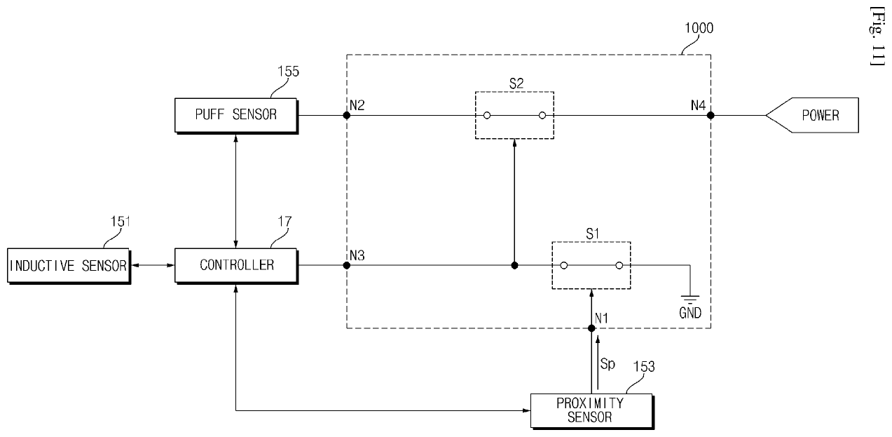

Referring to FIGS. 8 and 9, the aerosol generating device 10 may include an upper body 810 and/or a lower body 820. The upper body 810 and/or the lower body 820 may configure the external appearance of the aerosol generating device 10.

Hereinafter, the directions of the aerosol generating device 10 may be defined based on the orthogonal coordinate system. In the orthogonal coordinate system, the x-axis direction may be defined as the leftward-rightward direction of the aerosol-generating device. Here, based on the origin, the +x-axis direction may be the rightward direction, and the −x-axis direction may be the leftward direction. The y-axis direction may be defined as the forward-backward direction of the aerosol-generating device 10. Here, based on the origin, the +y-axis direction may be the forward direction, and the −y-axis direction may be the backward direction. The z-axis direction may be defined as the upward-downward direction of the aerosol-generating device 10. Here, based on the origin, the +z-axis direction may be the upward direction, and the −z-axis direction may be the downward direction.

The upper body 810 may accommodate various components for generating aerosol, such as the heater 110 and the sensors 151, 153, and 155 therein. The upper body 810 may have an insertion hole 811 formed therein. An upper side of the upper body 810 may be open to form the insertion hole 811. The insertion hole 811 may be formed at a position corresponding to the insertion space 130. The insertion space 130 may be formed in the upper body 810.

The upper body 810 may include a cover 813. The cover 813 may open and close the insertion space 130. The cover 813 may open and close an opening that exposes the insertion space 130 to the outside. The cover 813 may be disposed adjacent to the opening of the insertion space 130.

The cover 813 may be movably installed. The cover 813 may move to open and close the insertion space 130. For example, the cover 813 may slide in the backward direction along the upper surface of the upper body 810 to open the insertion space 130. For example, the cover 813 may slide in the forward direction along the upper surface of the upper body 810 to close the insertion space 130. Meanwhile, the method in which the cover 813 moves is not limited to sliding. For example, the cover 813 may open and close the insertion space 130 not only by a non-rotation method such as a sliding, but also by a rotation method such as a tilt and a hinge.

The upper body 810 may be disposed above the lower body 820. The upper body 810 may be coupled to the lower body 820.

The lower body 820 may accommodate various components for supply of power or control, such as the battery 16, the controller 17, and the printed circuit board 700. The lower body 820 may include a mount 821 supporting the upper body 810. The mount 821 may be configured to cover the upper side of the lower body 820.

According to one embodiment, a sealing member may be disposed inside the upper body 810. The sealing member may be made of a material having elasticity. For example, the sealing member may be made of a material such as rubber or silicon. The sealing member may be disposed between components disposed inside the upper body 810. The sealing member may prevent liquid substances generated in the upper body 810 in the process of generating aerosol from leaking through gaps between components disposed inside the upper body 810.

The mount 821 may include a through hole. At least one of the flexible printed circuit boards 710 to 740 may be disposed to pass through the through hole. The plurality of flexible printed circuit boards 710 to 740 may be electrically disconnected from each other. As the plurality of sensors 151, 153, and 155 are electrically isolated from each other, the effect of an error occurring in one of the plurality of sensors 151, 153, and 155 on the operation of the other sensor may be minimized.

The plurality of flexible printed circuit boards 710 to 740 disposed through the through hole may be electrically connected to the printed circuit board 700 disposed inside the lower body 820. For example, the plurality of flexible printed circuit boards 710 to 740 may be respectively coupled to a plurality of connectors mounted on the printed circuit board 700. For example, one end of the first flexible printed circuit board 710 may be electrically connected to the heater 110, and the other end of the first flexible printed circuit board 710 may be electrically connected to a first connector corresponding to the battery 16 among components mounted on the printed circuit board 700. For example, one end of the second flexible printed circuit board 720 may be electrically connected to the inductive sensor 150, and the other end of the second flexible printed circuit board 720 may be electrically connected to a second connector corresponding to the controller 17 among components mounted on the printed circuit board 700.

Referring to FIGS. 10 to 12, the aerosol generating device 10 may include a power circuit for supplying power to certain components. In the present disclosure, the power circuit 1000 for controlling the supply of power to the puff sensor 155 is described as an example, but is not limited thereto.

The power circuit 1000 may be electrically connected to the controller 17. The power circuit 1000 may be electrically connected to the proximity sensor 153. The power circuit 1000 may be electrically connected to the puff sensor 155.

The power circuit 1000 may include a first node N1 electrically connected to the proximity sensor 153, a second node N2 electrically connected to the puff sensor 155, a third node N3 electrically connected to the controller 17 and/or a fourth node N4 to which power is input.

The power circuit 1000 may control the supply of power to the puff sensor 155. The power circuit 1000 may control the supply of power to the puff sensor 155 based on a signal received from the controller 17 and/or the proximity sensor 153. For example, the power circuit 1000 may supply power to the puff sensor 155 based on a predetermined signal corresponding to insertion of the stick 20 being input from the proximity sensor 153. For example, the power circuit 1000 may supply power to the puff sensor 155 based on a predetermined signal corresponding to a state of the proximity sensor 153 being input from the controller 17.

The power circuit 1000 may include at least one switching element. Supply of power to the puff sensor 155 may be adjusted according to an operation of the switching element. The switching element included in the power circuit 1000 may operate according to a signal received from the controller 17 and/or the proximity sensor 153.

The power circuit 1000 may include a first switching element S1 disposed between the third node N3 and a ground GND. The power circuit 1000 may include a second switching element S2 disposed between the second node N2 and the fourth node N4.

The first switching element S1 may operate according to a signal output from the proximity sensor 153. The proximity sensor 153 may output a signal Sp corresponding to the insertion of an object (hereinafter referred to as an insertion signal) to the first node N1 based on the insertion of the object into the insertion space 130. For example, a state of the first node N1 corresponding to the input of the insertion signal Sp may be high, and the state of the first node N1 corresponding to no input of the insertion signal Sp may be low.

The first switching element S1 may be turned on according to the input of the insertion signal Sp through the first node N1. When the first switching element S1 is turned on, the third node N3 may be electrically connected to the ground GND. For example, the first switching element S1 may be turned on based on the state of the first node N1 being changed from low to high according to the input of the insertion signal Sp through the first node N1.

The second switching element S2 may operate according to a state of the third node N3. For example, the second switching element S2 may be turned off based on the state of the third node N3 being high and turned on based on the state of the third node N3 being low. Power input through the fourth node N4 may be supplied to the puff sensor 155 based on the second switching element S2 being turned on.

According to an embodiment, the third node N3 may be electrically connected to the ground GND based on the first switching element S2 being turned on according to the input of the insertion signal Sp through the first node N1. In this case, the state of the third node N3 may be changed from high to low based on the third node N3 being electrically connected to the ground GND.

The controller 17 may determine the state of the proximity sensor 153. For example, the liquid substance generated in the upper body 810 may interfere with an operation of the light-emitting element or the light-receiving element included in the proximity sensor 153 or cause a short circuit of a power line or signal line of the proximity sensor 153. At this time, the controller 17 may determine the state of the proximity sensor 153 based on a signal received from the proximity sensor 153.

According to an embodiment, the controller 17 may determine the state of the proximity sensor 153 based on whether a predetermined signal is received from the proximity sensor 153. For example, the controller 17 may determine that the proximity sensor 153 is defective when a response signal that is a response to a signal transmitted to the proximity sensor 153 is not received from the proximity sensor 153.

According to an embodiment, the controller 17 may determine that the proximity sensor 153 is defective when a signal received from the proximity sensor 153 and a signal received from the inductive sensor 151 do not correspond to each other. For example, when the stick 20 is detected by the inductive sensor 151 and the stick 20 is not detected by the proximity sensor 153, the controller 17 may determine that the proximity sensor 153 is defective. For example, when the stick 20 is not detected by the inductive sensor 151 and the stick 20 is detected by the proximity sensor 153, the controller 17 may determine that the proximity sensor 153 is defective.

The controller 17 may output a signal corresponding to the state of the proximity sensor 153 to the power circuit 1000. The signal corresponding to the state of the proximity sensor 153 output from the controller 17 may be input to the power circuit 1000 through the third node N3. For example, the controller 17 may output a signal Sc corresponding to a defect (hereinafter referred to as a fault signal) based on the proximity sensor 153 being defective. For example, the controller 17 may output a signal corresponding to normal (hereinafter referred to as a normal signal) based on the proximity sensor 153 being normal.

According to an embodiment, the fault signal Sc input through the third node N3 may be a signal corresponding to the ground GND. For example, while the normal signal is input to the power circuit 1000 through the third node N3, the state of the third node N3 may be high. The state of the third node N3 may correspond to the ground GND based on the fault signal Sc being input to the power circuit 1000 through the third node N3. At this time, based on the state of the third node N3 corresponding to the ground GND, the state of the third node N3 may be changed from high to low.

Meanwhile, the controller 17 may deactivate a function of the proximity sensor 153 based on the proximity sensor 153 being defective. For example, the controller 17 may control a power circuit for supplying power to the proximity sensor 153 so that the supply of power to the proximity sensor 153 is interrupted based on the proximity sensor 153 being defective.

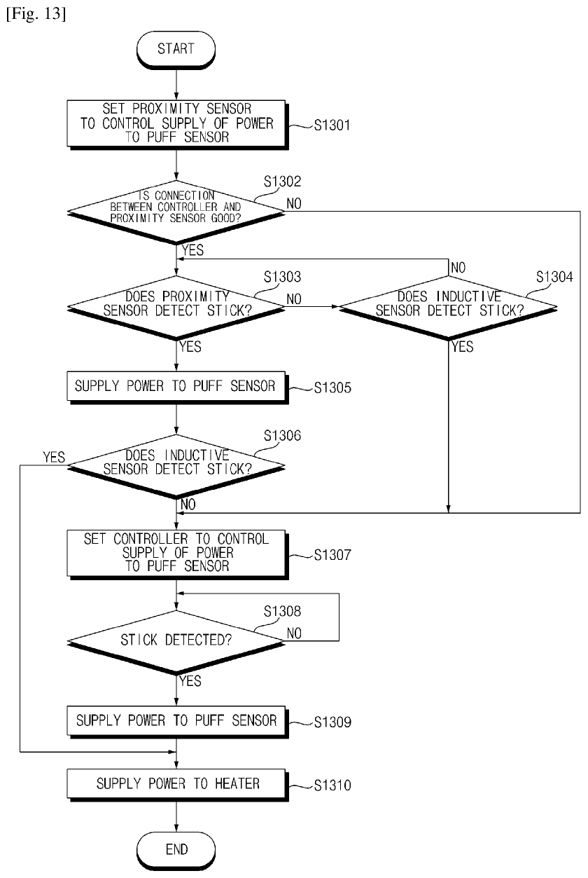

FIG. 13 is a flowchart showing an operation method of the aerosol-generating device according to an embodiment of the present disclosure.

Referring to FIG. 13, the aerosol generating device 10 may set the proximity sensor 153 to control supply of power to the puff sensor 155 in operation S1301. According to one embodiment, in a state in which the proximity sensor 153 is preset to control the supply of power to the puff sensor 155, an operation of each component provided in the aerosol generating device 10 may be started.

The aerosol generating device 10 may determine whether or not a connection between the controller 17 and the proximity sensor 153 is good in operation S1302. For example, the controller 17 of the aerosol generating device 10 may transmit a signal to the proximity sensor 153. At this time, when the response signal that is a response to the signal transmitted from the controller 17 to the proximity sensor 153 is not output from the proximity sensor 153, the aerosol generating device 10 may determine that the proximity sensor 153 is defective.

In operation S1303, the aerosol generating device 10 may determine whether the proximity sensor 153 detects the stick 20 based on a good connection between the controller 17 and the proximity sensor 153. For example, the aerosol generating device 10 may determine whether an object is inserted into the insertion space 130 based on a time from when light is emitted from the light-emitting element to when the light-receiving element reacts to a reflected light.

When an object is not inserted into the insertion space 130, light emitted from the light-emitting element toward the insertion space 130 may be reflected by the inner wall forming the insertion space 130 and may be incident to the light-receiving element. On the other hand, when an object is inserted into the insertion space 130, at least a part of the light emitted from the light-emitting element may be reflected by the object inserted into the insertion space 130 before being reflected by the inner wall forming the insertion space 130 and incident on the light-receiving element. Therefore, the aerosol generating device 10 may determine that the stick 20 is inserted into the insertion space 130 when the time from when light is emitted from the light-emitting element to when the light-receiving element reacts to the reflected light is less than a preset time.

According to an embodiment, the aerosol generating device 10 may determine whether the stick 20 is inserted into the insertion space 130 based on the color of the object inserted into the insertion space 130 detected through the color sensor. For example, the aerosol generating device 10 may determine that a new stick is inserted into the insertion space 130 based on the color of the object inserted into the insertion space 130 being the first color. For example, the aerosol generating device 10 may determine that a previously used stick is inserted into the insertion space 130 based on the color of the object inserted into the insertion space 130 being the second color.

According to an embodiment, the aerosol generating device 10 may determine whether the stick 20 is inserted into the insertion space 130 based on capacitance around the insertion space 130 detected through the capacitance sensor. For example, the aerosol generating device 10 may determine that the stick 20 is inserted into the insertion space 130 based on a degree of change in the level of the signal of the capacitance sensor being equal to or greater than a predetermined minimum level. For example, the aerosol generating device 10 may determine that the previously used stick 20 is inserted into the insertion space 130 when the degree of change in the level of the signal of the capacitance sensor being equal to or greater than a specific level greater than the minimum level.

When the stick 20 is not detected by the proximity sensor 153 in operation S1304, the aerosol generating device 10 may determine whether the inductive sensor 151 detects the stick 20. For example, the aerosol generating device 10 may determine that the stick 20 is inserted into the insertion space 130 when the inductance corresponding to the signal of the inductive sensor 151 changes by a predetermined value or more. For example, the aerosol generating device 10 may determine that the stick 20 is inserted into the insertion space 130 based on the inductance corresponding to the signal of the inductive sensor 151 exceeding a predetermined value.

The aerosol generating device 10 may continuously monitor whether the stick 20 is inserted into the insertion space 130 through the inductive sensor 151 and the proximity sensor 153 when the stick 20 is not detected by the inductive sensor 151 and the proximity sensor 153.

The aerosol generating device 10 may supply power to the puff sensor 155 when the stick 20 is detected by the proximity sensor 153 in operation S1305. For example, the power circuit 1000 may supply power to the puff sensor 155 according to the insertion signal Sp output from the proximity sensor 153 in response to insertion of the stick 20.

The aerosol generating device 10 may determine whether the inductive sensor 151 detects the stick 20 in operation S1306.

The aerosol generating device 10 may set the controller 153 to control supply of power to the puff sensor 155 in operation S1307. The aerosol generating device 10 may set the controller 17 to control the supply of power to the puff sensor 155 based on the proximity sensor 153 being defective. For example, the aerosol generating device 10 may set the controller 17 to control supply of power to the puff sensor 155 based on poor communication between the controller 17 and the proximity sensor 153. For example, the aerosol generating device 10 may set the controller 17 to control supply of power to the puff sensor 155 based on the stick 20 being detected through any one of the inductive sensor 151 and the proximity sensor 153.

Meanwhile, the aerosol generating device 10 may deactivate the function of the proximity sensor 153 based on the proximity sensor 153 being defective. At this time, based on the inactivation of the function of the proximity sensor 153, output of the insertion signal Sp from the proximity sensor 153 may be stopped.

When the controller 17 is set to control the supply of power to the puff sensor 155, the aerosol generating device 10 may monitor whether the inductive sensor 151 detects the stick 20 in operation S1308.

The aerosol generating device 10 may supply power to the puff sensor 155 based on the detection of the stick 20 through the inductive sensor 151 in operation S1309. For example, the controller 17 of the aerosol generating device 10 may output the fault signal Sc to the power circuit 1000 based on the detection of the stick 20 through the inductive sensor 151. At this time, the power circuit 1000 may supply power to the puff sensor 155 according to the fault signal Sc output from the controller 17.

The aerosol generating device 10 may supply power to the heater 110 in operation S1310. For example, the aerosol generating device 10 may supply power to the heater 110 based on the detection of the stick 20 through the inductive sensor 151 and the proximity sensor 153. For example, in a state in which the controller 17 is set to control the supply of power to the puff sensor 155, the aerosol generating device 10 may supply power to the heater 110 based on the detection of the stick 20 through the inductive sensor 151.

According to an embodiment, the aerosol generating device 10 may determine whether to supply power to the heater 110 based on the color of the stick 20 detected through the color sensor. For example, the aerosol generating device 10 may check the color of the stick 20 detected through the color sensor based on the detection of the stick 20 through the inductive sensor 151 and the proximity sensor 153. At this time, when it is identified that the color of the stick 20 is the second color, the aerosol generating device 10 may interrupt the supply of power to the heater 110.

As described above, according to at least one of the embodiments of the present disclosure, it may be possible to immediately activate a specific sensor upon insertion of a stick 20.

In addition, according to at least one of the embodiments of the present disclosure, it may be possible to appropriately change a configuration for controlling supply of power to a specific sensor according to circumstances.

In addition, according to at least one of the embodiments of the present disclosure, it may be possible to minimize an effect of an error occurring in any one of a plurality of sensors on other sensors.

Referring to FIGS. 1 to 13, an aerosol-generating device 10 in accordance with one aspect of the present disclosure may include a housing 101 having an insertion space 130, a heater 110 configured to heat a stick inserted into the insertion space 130, a first sensor 153, a second sensor 155, a power circuit 1000 configured to control supply of power to the second sensor 155, and a controller 17 electrically connected to each of the first sensor 153 and the second sensor 155. The first sensor 153 may output a first signal corresponding to s state of the insertion space 130 to the controller 17 and output a second signal corresponding to an insertion of the stick into the insertion space 130 to the power circuit 1000. The controller 17 may output a third signal corresponding to a fault to the power circuit 1000 based on the first sensor 153 being defective. The power circuit 1000 may supply the power to the second sensor 155 based on receiving at least one of the second signal or the third signal.

In addition, in accordance with another aspect of the present disclosure, the first sensor 153 may be an optical proximity sensor including a light-emitting element for emitting light and a light-receiving element for sensing light.

In addition, in accordance with another aspect of the present disclosure, the power circuit 1000 may comprise a first node N1 electrically connected to the first sensor 153, a second node N2 electrically connected to the second sensor 155, a third node N3 electrically connected to the controller 17, a fourth node N4 to which the power is input, a first switching element S1 disposed between the third node N3 and a ground GND and a second switching element S2 disposed between the second node N2 and the fourth node N4.

In addition, in accordance with another aspect of the present disclosure, the first switching element S1 may be turned on so that the third node N3 and the ground GND are electrically connected, based on the second signal being input through the first node N1. The second switching element S2 may be turned on so that the first node N1 and the fourth node N4 are electrically connected, based on the third node N3 corresponding to the ground GND. The third node N3 may correspond to the ground GND according to an input of the third signal through the third node N3.

In addition, in accordance with another aspect of the present disclosure, the controller 17 may determine that the first sensor 153 is defective when a response signal that is a response to a signal transmitted to the first sensor 153 is not received from the first sensor 153.

In addition, in accordance with another aspect of the present disclosure, the aerosol generating device 10 may further comprise a third sensor 151 configured to output a fourth signal corresponding to a state of the insertion space 130. The controller 17 may determine that the first sensor 153 is normal when the first signal and the fourth signal correspond to each other and determine that the first sensor 153 is defective when the first signal and the fourth signal do not correspond to each other.

In addition, in accordance with another aspect of the present disclosure, the controller 17 may control so that the power is supplied to the heater 110 based on both the first signal and the fourth signal corresponding to the insertion of the stick, when the first sensor 153 is normal, and control so that the power is supplied to the heater 110 based on the fourth signal corresponding to the insertion of the stick, when the first sensor 153 is defective.

In addition, in accordance with another aspect of the present disclosure, the third sensor 151 may be an inductive sensor including a coil. The fourth signal may correspond to a characteristic of the current flowing through the coil.

In addition, in accordance with another aspect of the present disclosure, the second sensor 155 may be a puff sensor configured to detect user's inhalation.

In addition, in accordance with another aspect of the present disclosure, the housing 101 may comprise an upper body 810 in which the heater 110, the first sensor 153, and the second sensor 155 are disposed and a lower body 820 in which the controller 17 and a battery 16 supplying the power. The first sensor 153 may be electrically connected to the controller 17 through a first signal line. The second sensor 155 may be electrically connected to the controller 17 through a second signal line electrically disconnected to the first signal line.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a housing having an insertion space;
a heater configured to heat a stick inserted into the insertion space;
a first sensor;
a second sensor;
a power circuit configured to control supply of power to the second sensor; and
a controller electrically connected to each of the first sensor and the second sensor,
wherein the first sensor is configured to:
output a first signal to the controller corresponding to a state of the insertion space, and
output a second signal to the power circuit corresponding to insertion of the stick into the insertion space,
wherein the controller is configured to determine whether the first sensor is defective based on the first signal, and to output a third signal to the power circuit based on the first sensor being defective, and
wherein the power circuit is configured to supply the power to the second sensor based on receiving at least one of the second signal or the third signal.

2. The aerosol-generating device according to claim 1, wherein the first sensor is an optical proximity sensor including a light-emitting element for emitting light and a light-receiving element for sensing light.

3. The aerosol-generating device according to claim 1, wherein the power circuit comprises:
a first node electrically connected to the first sensor;
a second node electrically connected to the second sensor;
a third node electrically connected to the controller;
a fourth node to which the power is input;
a first switching element disposed between the third node and a ground; and
a second switching element disposed between the second node and the fourth node.

4. The aerosol-generating device according to claim 3, wherein the first switching element is configured to electrically connect the third node and the ground based on the second signal being input through the first node, and
wherein the second switching element is configured to electrically connect the first node and the fourth node based on the third node corresponding to the ground according to the third signal being output to the power circuit through the third node.

5. The aerosol-generating device according to claim 1, wherein the controller is configured to determine that the first sensor is defective based on not receiving a response signal from the first sensor in response to a signal transmitted to the first sensor.

6. The aerosol-generating device according to claim 1, further comprising a third sensor configured to output a fourth signal corresponding to the state of the insertion space,
wherein the controller is configured to:
determine that the first sensor is normal based on the first signal and the fourth signal corresponding to each other, and
determine that the first sensor is defective based on the first signal and the fourth signal not corresponding to each other.

7. The aerosol-generating device according to claim 6, wherein the controller is configured to:
based on the first sensor being normal, cause the power to be supplied to the heater based on both the first signal and the fourth signal indicating insertion of the stick, and
based on the first sensor being defective, cause the power to be supplied to the heater based only on the fourth signal indicating insertion of the stick.

8. The aerosol-generating device according to claim 6, wherein the third sensor is an inductive sensor including a coil,
wherein the fourth signal corresponds to a characteristic of the current flowing through the coil.

9. The aerosol-generating device according to claim 1, wherein the second sensor is a puff sensor configured to detect inhalation by a user.

10. The aerosol-generating device according to claim 1, wherein the housing comprises:
an upper body in which the heater, the first sensor, and the second sensor are disposed; and
a lower body in which the controller and a battery supplying the power are disposed,
wherein the first sensor is electrically connected to the controller through a first signal line, and
wherein the second sensor is electrically connected to the controller through a second signal line which is not electrically connected to the first signal line.
